(19) United States
(12) Patent Application Publication
(10) Pub. No.: US 2026/0045044 A1
(43) Pub. Date: Feb. 12, 2026

(54) PATH PROCESSING METHOD AND APPARATUS IN VIRTUAL SCENE, DEVICE, AND STORAGE MEDIUM

(71) Applicant: TENCENT TECHNOLOGY (SHENZHEN) COMPANY LIMITED, Shenzhen (CN)

(72) Inventor: Ziqi WEI, Shenzhen (CN)

(21) Appl. No.: 19/360,966

(22) Filed: Oct. 16, 2025

Related U.S. Application Data
(63) Continuation of application No. PCT/CN2024/120743, filed on Sep. 24, 2024.

(30) Foreign Application Priority Data
Dec. 21, 2023 (CN) 202311777012.0

(51) Int. Cl. G06T 19/00; A63F 13/5372; G06T 19/20

(52) U.S. Cl. CPC G06T 19/003; A63F 13/5372; G06T 19/20; G06T 2219/2004

(57) ABSTRACT

A path processing method and apparatus in a virtual scene, and relates to the field of virtual world technologies. The method includes displaying the virtual scene and a start recording control; controlling the first terminal to enter a path recording mode in response to receiving a trigger operation on the start recording control; obtaining path information in response to that the first terminal is in the path recording mode and receives at least one marking operation, and the target path being a path formed by sequentially connecting an initial position to at least one marked position, the path information being configured for indicating a target path, the marked position being a position of the first virtual object, and the first virtual object being controlled by the first terminal; and transmitting the path information to a second terminal, the second terminal presenting guidance information of the target path.

### RELATED APPLICATIONS

This application claims priority to PCT Application No. PCT/CN2024/120743, filed on Sep. 24, 2024, which claims priority to Chinese Patent Application No. 202311777012.0, entitled “PATH PROCESSING METHOD AND APPARATUS IN VIRTUAL SCENE, DEVICE, AND STORAGE MEDIUM”, filed with the China National Intellectual Property Administration on Dec. 21, 2023, which are incorporated herein by reference in their entirety.

### FIELD OF THE TECHNOLOGY

This application relates to the field of virtual world technologies, and in particular, to a path processing method and apparatus in a virtual scene, a device, and a storage medium.

### BACKGROUND OF THE DISCLOSURE

In virtual scenes of games such as MMO and open world, there are some special multi-section quests, and these quests usually require a player to perform interaction at a plurality of hidden places.

Often, the player may obtain position information of the hidden places one by one by using position coordinates transmitted by a friend or by searching for a strategy on a web page, then manually control a virtual object to move to a corresponding place in the virtual scene, and interact with a virtual item or another virtual object in the place, to complete a quest section at the place. After completing the quest section at the place, the player may manually control the virtual object to move to a next place based on position information of the next place.

However, in the solution shown in the foregoing related technology, the player needs to obtain position information of each quest place one by one and manually control the virtual object to reach a corresponding position. Consequently, an operation of the player is complex, and efficiency of interaction between the player and the virtual scene is affected.

### SUMMARY

This application provides a path processing method and apparatus in a virtual scene, a device, and a storage medium. The technical solutions are described below.

According to an aspect of this application, a path processing method in a virtual scene is provided, the method being performed by a first terminal, and including: displaying the virtual scene and a start recording control; controlling the first terminal to enter a path recording mode in response to receiving a trigger operation on the start recording control; obtaining path information in response to that the first terminal is in the path recording mode and receives at least one marking operation, and the target path being a path formed by sequentially connecting an initial position to at least one marked position, the path information being configured for indicating a target path, the initial position being a position of a first virtual object when the first terminal enters the path recording mode, the marked position being a position of the first virtual object when the first terminal receives the marking operation, and the first virtual object being controlled by the first terminal; and transmitting the path information to a second terminal, the second terminal presenting guidance information of the target path based on the path information.

According to an aspect of this application, a path processing method in a virtual scene is provided, the method being performed by a second terminal and including: receiving path information transmitted by a first terminal, the path information being obtained by the first terminal when the first terminal is in a path recording mode and receives at least one marking operation, the path information being configured for indicating a target path, and the target path being a path formed by sequentially connecting an initial position to at least one marked position; the initial position being a position of a first virtual object when the first terminal enters the path recording mode, the marked position being a position of the first virtual object when the first terminal receives the marking operation; and the first virtual object being a virtual object controlled by the first terminal; presenting guidance information of the target path based on the path information; and controlling a second virtual object to sequentially move between the initial position and one or more marked positions in response to receiving a trigger operation on the guidance information.

According to another aspect of this application, a computer device is provided. The computer device includes a processor and a memory, and the memory has at least one instruction, at least one program, and a code set or an instruction set stored therein. The at least one instruction, the at least one program, and the code set or the instruction set are loaded and executed by the processor, to implement the path processing method in a virtual scene in the foregoing aspects.

According to another aspect of this application, a non-transitory computer-readable storage medium is provided. The readable storage medium has at least one instruction, at least one program, and a code set or an instruction set stored therein. The at least one instruction, the at least one program, and the code set or the instruction set are loaded and executed by a processor, to implement the path processing method in a virtual scenario in the foregoing aspects.

In embodiments of the present application, when the first terminal is in the path recording mode and receives the at least one marking operation, the first terminal may obtain the path information. The path information may indicate the initial position of the first virtual object when the first terminal enters the path recording mode, and the marked position of the first virtual object when the marking operation is received. The first terminal may transmit the path information to the second terminal. The second terminal presents the guidance information of the target path based on the path information, and controls, when the second terminal receives the trigger operation on the guidance information, the second virtual object to sequentially move between the initial position and the one or more marked positions. In the process of controlling the first virtual object to respectively complete corresponding quests at a plurality of positions, a player of the first terminal may mark each position, record related marking information, to generate the path information, and share the path information with a player of the second terminal. In this case, the second terminal controls, based on the guidance information generated based on the path information, the second virtual object to sequentially arrive at the foregoing each position, to complete a corresponding quest, thereby simplifying a procedure of synchronizing or notifying information about the plurality of positions between users, and further improving interaction efficiency when a user controls a virtual object in the virtual scene.

### BRIEF DESCRIPTION OF THE DRAWINGS

FIG. 1 is a structural block diagram of a computer system according to an embodiment of this application.

FIG. 2 is a flowchart of a path processing method in a virtual scene according to an embodiment of this application.

FIG. 3 is a schematic diagram of a start recording control according to an embodiment of this application.

FIG. 4 is a schematic diagram of a recording mode interface according to an embodiment of this application.

FIG. 5 is a flowchart of a path processing method in a virtual scene according to another embodiment of this application.

FIG. 6 is a schematic diagram of a dotting interface according to an embodiment of this application.

FIG. 7 is a flowchart of a path processing method in a virtual scene according to still another embodiment of this application.

FIG. 8 is a schematic diagram of an interaction interface according to an embodiment of this application.

FIG. 9 is a schematic diagram of a remark interface according to an embodiment of this application.

FIG. 10 is a schematic diagram of a remarked interface according to an embodiment of this application.

FIG. 11 is a flowchart of a path processing method in a virtual scene according to yet another embodiment of this application.

FIG. 12 is a schematic diagram of an end recording interface according to an embodiment of this application.

FIG. 13 is a schematic diagram of a path information interface according to an embodiment of this application.

FIG. 14 is a schematic diagram of a sharing interface according to an embodiment of this application.

FIG. 15 is a schematic diagram of a path guiding interface according to an embodiment of this application.

FIG. 16 is a flowchart of path recording according to an embodiment of this application.

FIG. 17 is a flowchart of transmitting path information according to an embodiment of this application.

FIG. 18 is a flowchart of generating a path quest according to an embodiment of this application.

FIG. 19 is a structural block diagram of a path processing apparatus in a virtual scene according to an embodiment of this application.

FIG. 20 is a structural block diagram of a path processing apparatus in a virtual scene according to an embodiment of this application.

FIG. 21 is a structural block diagram of a computer device according to an embodiment of this application.

### DESCRIPTION OF EMBODIMENTS

User information (including but not limited to user equipment information, user personal information, and the like) and data (including but not limited to data for analysis, stored data, displayed data, and the like) involved in this application both are information and data authorized by a user or fully authorized by all parties, and the collection, use, and processing of relevant data need to comply with the related laws, regulations, and standards of related countries and regions. For example, object behavior such as an attack operation involved in this application is obtained with full authorization.

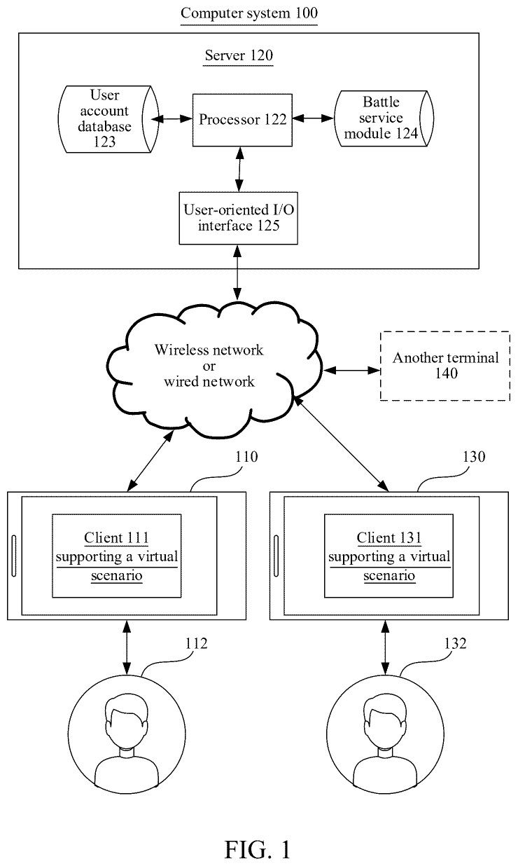

FIG. 1 is a structural block diagram of a computer system according to an embodiment of this application. The computer system 100 includes a first terminal 110, a server 120, and a second terminal 130.

A client 111 supporting a virtual scene is installed and run on the first terminal 110. The client 111 may be a multiplayer online battle program. When the first terminal runs the client 111, a user interface of the client 111 is displayed on a screen of the first terminal 110. The client 111 may be any one of a simulation program, an escape shooting game, a virtual reality (VR) application, an augmented reality (AR) program, a three-dimensional map program, a virtual reality game, an augmented reality game, a first-person shooting (FPS) game, a third-person shooting (TPS) game, a multiplayer online battle arena (MOBA) game, and a simulation game (SLG). In this embodiment, an example in which the client 111 is the FPS game is used for description. The first terminal 110 is a terminal used by a first user 112. The first user 112 uses the first terminal 110 to control a first virtual object located in the virtual scene to perform an activity, and the first virtual object may be referred to as a virtual object of the first user 112. The activity of the first virtual object includes but is not limited to at least one of moving, jumping, teleporting, releasing a skill, using an item, adjusting a body posture, crawling, walking, running, riding, flying, jumping, driving, picking, shooting, attacking, and throwing. For example, the first virtual object is a first virtual object like a simulated human character or a cartoon human character.

A client 131 supporting the virtual scene is installed and run on the second terminal 130. The client 131 may be a multiplayer online battle program. When the second terminal 130 runs the client 131, a user interface of the client 131 is displayed on a screen of the second terminal 130. The client may be any one of a simulation program, an escape shooting game, a VR application, an AR program, a three-dimensional map program, a virtual reality game, an augmented reality game, an FPS, a TPS, an MOBA, and an SLG. In this embodiment, an example in which the client is an MOBA game is used for description. The second terminal 130 is a terminal used by a second user 132. The second user 132 uses the second terminal 130 to control a second virtual object located in the virtual scene to perform an activity, and the second virtual object may be referred to as a virtual object of second first user 132. For example, the second virtual object is a second virtual object like a simulated human character or a cartoon human character.

In one embodiment, the first virtual object and the second virtual object are in a same virtual scene. In one embodiment, the first virtual object and the second virtual object may belong to a same camp, a same team, a same organization, have a friend relationship with each other, or have a temporary communication permission. In one embodiment, the first virtual object and the second virtual object may belong to different camps, different teams, different organizations, or have a hostile relationship with each other.

In one embodiment, clients installed on the first terminal 110 and the second terminal 130 are the same, or the clients installed on the two terminals are same-type clients of different operating system platforms (Android or iOS). The first terminal 110 may generally be one of a plurality of terminals, and the second terminal 130 may generally be another one of the plurality of terminals. In this embodiment, the first terminal 110 and the second terminal 130 are merely used as an example for description. Device types of the first terminal 110 and the second terminal 130 are the same or different. The device types include at least one of a smartphone, a tablet computer, an e-book reader, an MP3 player, an MP4 player, a laptop portable computer, and a desktop computer.

FIG. 1 shows only two terminals, but a plurality of other terminals 140 may access the server 120 in different embodiments. In one embodiment, one or more terminals 140 also exist, and are terminals corresponding to a developer. A development and editing platform of the client supporting the virtual scene is installed on the terminal 140. The developer may edit and update the client on the terminal 140, and transmit an updated client installation package to the server 120 through a wired network or a wireless network. The first terminal 110 and the second terminal 130 may download the client installation package from the server 120 to update the client.

The first terminal 110, the second terminal 130, and another terminal 140 are connected to the server 120 through the wireless network or the wired network.

The server 120 includes at least one of one server, a plurality of servers, a cloud computing platform, or a virtualization center. The server 120 is configured to provide a backend service for a client supporting a three-dimensional virtual scene. In one embodiment, the server 120 takes primary computing work, and the terminal takes secondary computing work. Alternatively, the server 120 takes secondary computing work, and the terminal takes primary computing work. Alternatively, the server 120 and the terminal perform cooperative computing by using a distributed computing architecture.

In an exemplary example, the server 120 includes a processor 122, a user account database 123, a battle service module 124, and a user-oriented input/output interface (I/O interface) 125. The processor 122 is configured to: load instructions stored in the server 120, and process data in the user account database 123 and the battle service module 124. The user account database 123 is configured to store data of user accounts used by the first terminal 110, the second terminal 130, and the another terminal 140, such as portraits of the user accounts, nicknames of the user accounts, fighting power indexes of the user accounts, and service areas of the user accounts. The battle service module 124 is configured to provide a plurality of battle rooms for battles between users, such as 1V1 battles, 3V3 battles, and 5V5 battles. The user-oriented I/O interface 125 is configured to establish communication exchange data with the first terminal 110 and/or the second terminal 130 through the wireless network or the wired network.

The method provided in this application may be but is not limited to being applied to at least one of the following scenarios: a virtual reality application, a three-dimensional map program, a simulation program, a first-person shooting (FPS) game, a third-person shooting (TPS) game, a multiplayer online battle arena (MOBA) game, a multiplayer shooter survival game, or the like. The following embodiments are described by using an example of application in a game.

In games such as an open world and massive multiplayer online (MMO) game, for a hidden quest with a plurality of sections, a player may search for a corresponding strategy from the outside of the game via an external auxiliary tool, and copy corresponding coordinate points to the game to perform guidance; or obtain hidden position information by receiving coordinate values corresponding to a corresponding quest node that are transmitted by a friend who has completed or is executing the quest; or search for a corresponding strategy video on another video platform, and complete the quest progressively based on a procedure in the video.

When the player wants to notify a friend to perform a quest (such as photographing, picking up an object, interacting with a non-player character (NPC), or performing an attack action) at several specific positions, the player may transmit positions of coordinate points one by one, or the current player becomes a team leader and invites another teammate to be teleported to the positions.

In the foregoing solution, as the game has no internal guide mechanism, the player needs to continuously copy information (for example, position information) corresponding to a single quest node, to assist the player in controlling a virtual object to explore in the virtual scene. An operation process is complicated and operation costs are high.

Although the player can view a corresponding position by searching for position information of a quest by watching a strategy video, the player needs to pause the video to view coordinate points provided by a corresponding answerer, and input the viewed coordinate points into the game. Operations are inconvenient and incoherent, and cannot be applied to the game to perform path guidance.

A team inviting teleportation manner requires a team leader player to first control a virtual object of the team leader player to arrive at a corresponding position, which is restrictive and cannot convey positions of a plurality of quest points without limiting a position of another player.

For the foregoing problems, subsequent solutions in this application provide another solution that implements notification of path information in a virtual scene between players. A player may record, one time, information about a path formed by a plurality of positions, and notify another player of the information. A terminal of another player guides, based on the information about the path, a virtual object to move between the plurality of positions in the virtual scene.

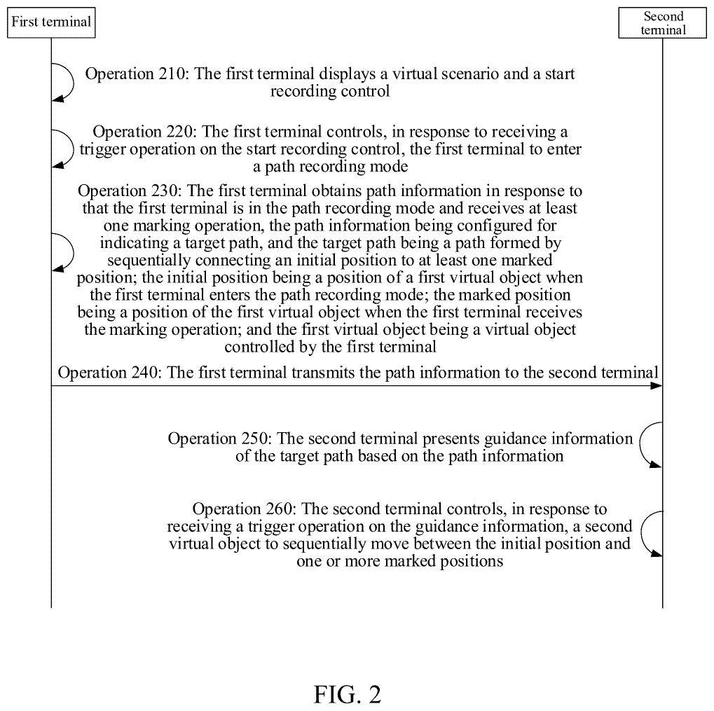

Refer to FIG. 2. FIG. 2 is a flowchart of a path processing method in a virtual scene according to an embodiment of this application. The method is performed by a computer device. In one embodiment, the computer device may be the first terminal 110 or the second terminal 130 in the system shown in FIG. 1. As shown in FIG. 2, the method may include the following operation 210, operation 220, operation 230, operation 240, operation 250, and operation 260.

Operation 210: The first terminal displays a virtual scene and a start recording control.

In one embodiment, the first terminal displays an interface of the virtual scene, and the interface of the virtual scene includes the start recording control.

For example, the virtual scene is configured for providing a virtual game between different virtual objects. A player controls one or more virtual objects by using a user account logged in to the terminal.

An application that runs or displays the virtual scene may be installed in the first terminal, and the application may display the interface of the virtual scene.

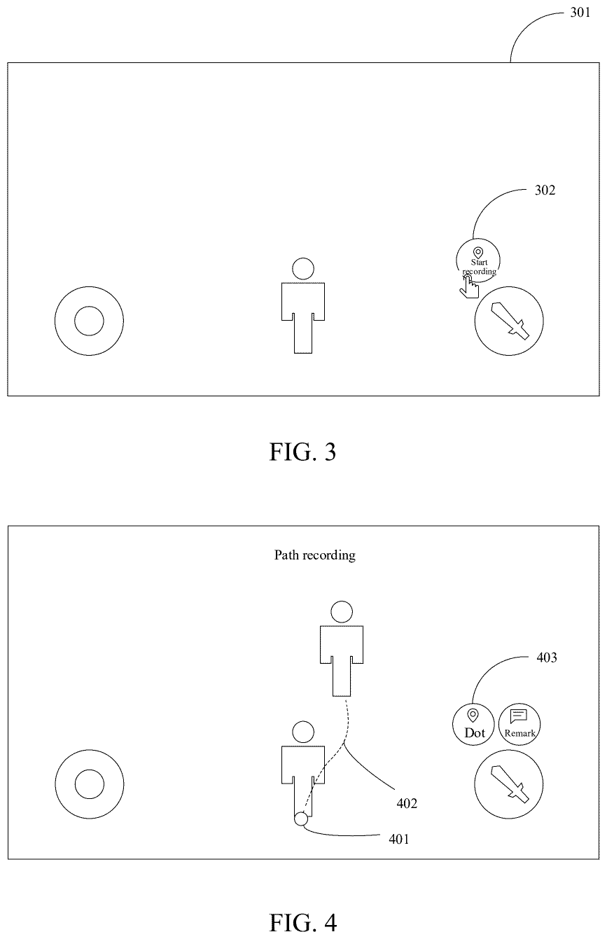

Refer to FIG. 3. FIG. 3 is a schematic diagram of a start recording control according to an embodiment of this application. As shown in FIG. 3, in one embodiment, the first terminal presents an interface 301 of the virtual scene including a start recording control 302 to the player, and the player may click/tap the “Start recording” control 302 on the first terminal to turn on a path recording mode.

Operation 220: Control, in response to receiving a trigger operation on the start recording control, the first terminal to enter a path recording mode.

In one embodiment, after the player clicks/taps the start recording control on the first terminal, the first terminal receives the trigger operation of the player, and enters the path recording mode.

For example, when the first terminal enters the path recording mode, an application in the first terminal may obtain a position of a virtual object controlled by the player, that is, obtain a corresponding start position of the virtual object when the player turns on the path recording mode.

For example, after the first terminal enters the path recording mode, the player may perform dotting at a position that the player wants to mark. The player may click/tap a related control on the terminal to perform dotting. Correspondingly, the first terminal may mark the position at which the player performs dotting.

For example, after the player completes path recording, the first terminal may use recorded information such as the initial position and one or more marked positions to generate path information that can be shared with another player.

In one embodiment, the foregoing controlling the first terminal to enter the path recording mode may refer to controlling the first terminal to start recording a path in the virtual scene.

Operation 230: The first terminal obtains path information in response to that the first terminal is in the path recording mode and receives at least one marking operation, the path information being configured for indicating a target path, and the target path being a path formed by sequentially connecting an initial position to at least one marked position; the initial position being a position of a first virtual object when the first terminal enters the path recording mode; the marked position being a position of the first virtual object when the first terminal receives the marking operation; and the first virtual object being a virtual object controlled by the first terminal.

In one embodiment, after the first terminal enters the path recording mode, if receiving one or more marking operations of the player, the first terminal obtains the sharable path information that is configured for indicating the target path.

The first terminal obtains, when the first terminal just enters the path recording mode, position information of the virtual object controlled by the first terminal, that is, the initial position of the first virtual object. The first terminal obtains, when receiving the marking operation of the player, the position information of the virtual object controlled by the first terminal, that is, the marked position of the first virtual object.

The foregoing target path is a path formed by sequentially connecting the initial position to one or more marked positions. Specifically, the foregoing target path is a path formed by sequentially connecting, from the initial position based on an execution sequence of marking operations respectively corresponding to the one or more marked positions, the initial position to the one or more marked positions.

For example, assuming that the foregoing initial position is a position 1, a position where the first virtual object receives a marking operation for the first time in a process in which the first terminal is in the path recording mode is a position 2, and a position where the first virtual object receives a marking operation for the second time in the process in which the first terminal is in the path recording mode is a position 3, an order of positions in the target path generated by the first terminal is: position 1→position 2→position 3.

In one embodiment, the foregoing path information may include information about the initial position and the one or more marked positions in the target path. For example, the foregoing path information may include respective coordinates and an arrangement order of the initial position and the one or more marked positions on the target path.

Refer to FIG. 4. FIG. 4 is a schematic diagram of a recording mode interface according to an embodiment of this application.

As shown in FIG. 4, after the recording mode is entered, dotting is performed by default on a starting point 401 at which the first virtual object enters the recording mode. When the player controls the first virtual object to move, a corresponding path record 402 is under the feet of the first virtual object. The player may click/tap a “Dot” control 403 to record the marked position.

Operation 240: The first terminal transmits the path information to the second terminal. Correspondingly, the second terminal receives the path information transmitted by the first terminal.

In one embodiment, after the player shares the path information at the terminal, the first terminal transmits the path information to the second terminal corresponding to a sharing object of the player.

Correspondingly, the second terminal receives the path information transmitted by the first terminal, so that a player of the second terminal can obtain path recording information shared by the player of the first terminal.

Operation 250: The second terminal presents guidance information of the target path based on the path information.

In one embodiment, the second terminal may present the guidance information of the corresponding target path to the player of the second terminal based on the path information transmitted by the first terminal, so that the player of the second terminal may complete a related quest based on the guidance information.

A process of the foregoing presenting the guidance information of the target path based on the path information may include: The second terminal generates the foregoing guidance information corresponding to the target path indicated by the path information, and displays the guidance information on a display of the second terminal.

The guidance information may be information for guiding the player of the second terminal to control the virtual object to move along the target path. For example, the guidance information may include a graphic element or text for indicating a plurality of positions on the target path.

Operation 260: The second terminal controls, in response to receiving a trigger operation on the guidance information, a second virtual object to sequentially move between the initial position and one or more marked positions.

In one embodiment, the player of the second terminal may click/tap a related control of the virtual interface to obtain the specific guidance information. When receiving the trigger operation performed by the player on the guidance information, the second terminal controls the second virtual object to sequentially move between the initial position and the marked position based on the guidance information.

In conclusion, according to the method provided in this embodiment, the first terminal may display the interface of the virtual scene including the start recording control, and enter the path recording mode when receiving the trigger operation on the start recording control. When the first terminal is in the path recording mode and receives the at least one marking operation, the first terminal may obtain the path information. The path information may indicate the initial position of the first virtual object when the first terminal enters the path recording mode, and the marked position of the first virtual object when the marking operation is received. The first terminal may transmit the path information to the second terminal. The second terminal presents the guidance information of the target path based on the path information, and controls, when receiving the trigger operation on the guidance information, the second virtual object to sequentially move between the initial position and the one or more marked positions. In the foregoing solution, in a process of controlling the first virtual object to respectively complete corresponding quests at a plurality of positions, the player of the first terminal may mark each position, record related marking information, to generate the path information, and share the path information with the player of the second terminal. In this case, the second terminal controls, based on the guidance information generated based on the path information, the second virtual object to sequentially arrive at the foregoing each position, to complete a corresponding quest, thereby simplifying a procedure of synchronizing or notifying information about the plurality of positions between users, and further improving interaction efficiency when a user controls a virtual object in the virtual scene.

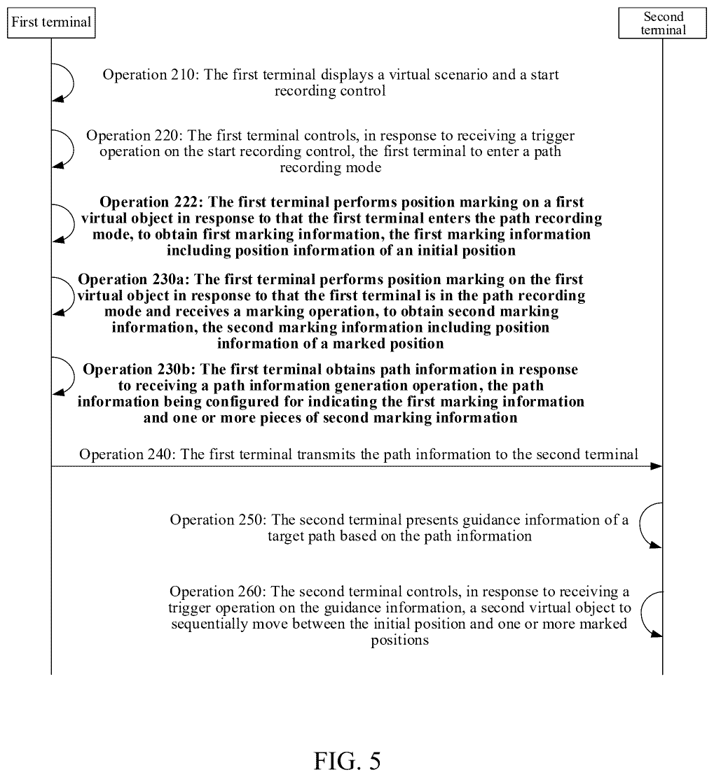

Based on the solution in the embodiment as shown in FIG. 2, refer to FIG. 5. FIG. 5 is a flowchart of a path processing method in a virtual scene according to another embodiment of this application. The method is performed by a computer device. In one embodiment, the computer device may be the first terminal 110 or the second terminal 130 in the system shown in FIG. 1. As shown in FIG. 5, before the foregoing operation 230, operation 222 is further included, and operation 230 may be implemented as operation 230a and operation 230b.

Operation 222: The first terminal performs position marking on a first virtual object in response to that the first terminal enters the path recording mode, to obtain first marking information, the first marking information including position information of an initial position.

The foregoing process in which the first terminal performs position marking on the first virtual object may refer to a process in which the first terminal records the position information (for example, coordinates in the virtual scene) corresponding to the first virtual object.

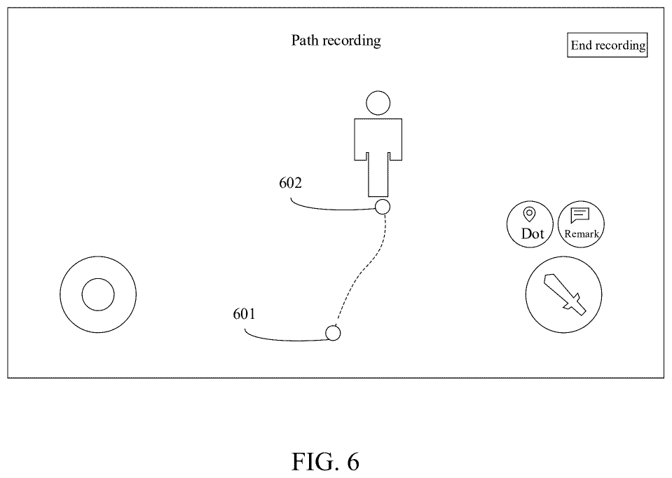

Refer to FIG. 6. FIG. 6 is a schematic diagram of a dotting interface according to an embodiment of this application.

In one embodiment, after the player turns on the path recording mode, the first terminal enters the path recording mode, and performs position marking on the first virtual object, to obtain the first marking information including the position information of the initial position. As shown in FIG. 6, when the player turns on the path recording mode, the first terminal obtains an initial position 601 corresponding to the first virtual object.

Operation 230a: The first terminal performs position marking on the first virtual object in response to that the first terminal is in the path recording mode and receives a marking operation, to obtain second marking information, the second marking information including position information of a marked position.

In one embodiment, after entering the path recording mode, the player may perform dotting at a position that the player wants to mark. The player may click/tap a related control on the terminal to perform dotting.

When the first terminal enters the path recording mode and receives the marking operation, the first terminal obtains the current position information of the first virtual object, that is, when the player clicks/taps to perform dotting, the first terminal obtains the position information corresponding to the first virtual object.

As shown in FIG. 6, after controlling the first virtual object to reach a specific area, the player may click/tap “Dot” to perform dotting, and the first terminal marks a current position with a marked point. After the player performs dotting, a new quest path point 602 (namely, the foregoing marked position) is generated under the feet of the first virtual object.

Operation 230b: The first terminal obtains path information in response to receiving a path information generation operation, the path information being configured for indicating the first marking information and one or more pieces of second marking information.

In one embodiment, after completing path recording, the player can use recorded information such as the first marking information and the second marking information, to generate the sharable path information. The player can perform operations such as generating and sharing by clicking/taping related controls on the terminal.

When the first terminal receives the path information generation operation, the first terminal obtains the path information configured for indicating the first marking information and the one or more pieces of second marking information.

One embodiment provides a path information obtaining solution, specifically including: obtaining the first marking information including the position information of the initial position of the first virtual object, and the second marking information including the position information of the marked position of the first virtual object; and obtaining the path information configured for indicating the first marking information and the one or more pieces of second marking information. In this solution, the initial position at which the first virtual object enters the path recording mode and the marked position at which the first virtual object is in the path recording mode can be obtained, to generate the path information, so that the player of a first terminal can share the initial position and the marked position with the player of the second terminal, and the second terminal generates the guidance information based on the path information.

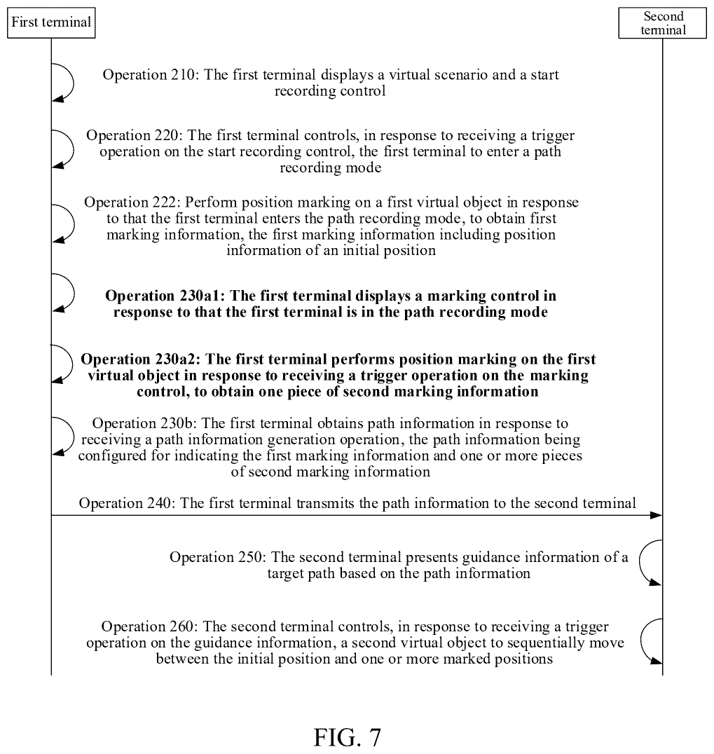

Based on the solution shown in any one or more of the foregoing embodiments of this application, specifically, for example, based on the solution in the embodiment shown in FIG. 5, refer to FIG. 7. FIG. 7 is a flowchart of a path processing method in a virtual scene according to still another embodiment of this application. The method is performed by a computer device. In one embodiment, the computer device may be the first terminal 110 or the second terminal 130 in the system shown in FIG. 1. As shown in FIG. 5, the foregoing operation 230a may be implemented as operation 230al and operation 230a2.

Operation 230a1: The first terminal displays a marking control in response to that the first terminal is in the path recording mode. For example, the first terminal displays the marking control on the interface of the virtual scene.

In one embodiment, when the first terminal is in the path recording mode, the marking control used by the player of the first terminal to perform a marking operation is displayed on the interface of the virtual scene corresponding to the first terminal.

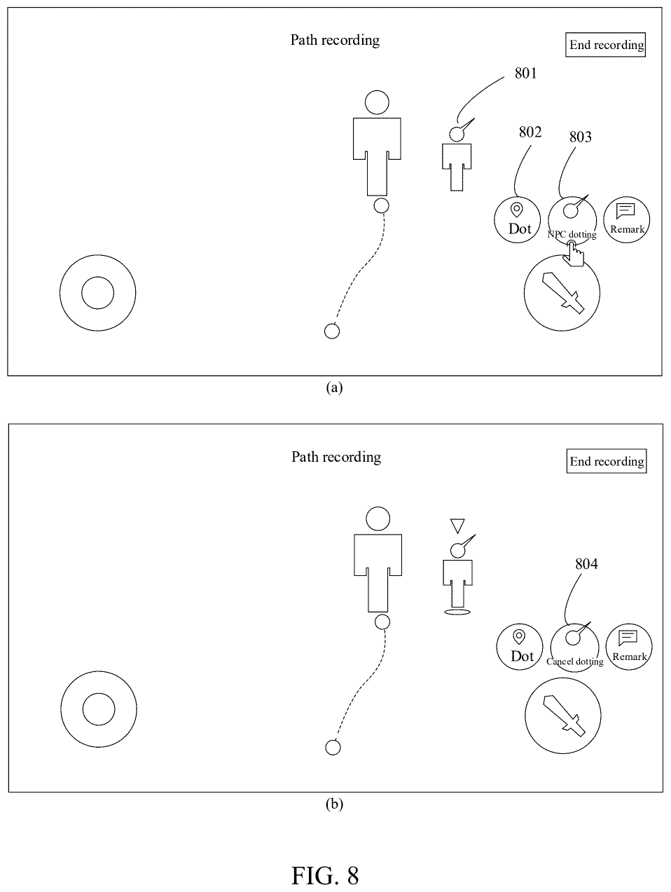

The marking control may be a marking control corresponding to the first virtual object, namely, a “Dot” control 403 in FIG. 4; or may be a marking control corresponding to another virtual object around the first virtual object, for example, an “NPC dotting” control 803 in FIG. 8.

Operation 230a2: The first terminal performs position marking on the first virtual object in response to receiving a trigger operation on the marking control, to obtain one piece of second marking information.

In one embodiment, when the player of the first terminal triggers the marking control, position marking is performed on the first virtual object, and one piece of second marking information including a marked position is obtained.

One embodiment provides a second marking information obtaining solution, including: displaying the marking control on the interface of the virtual scene; and obtaining, by the first terminal, one piece of second marking information when the marking control is triggered. This solution enables the player of the first terminal to intuitively perform a clicking/tapping operation on the virtual interface, to perform position marking on the first virtual object through a simple operation.

When a virtual item or an NPC that can perform interaction exists near the first virtual object controlled by the player, the first terminal automatically identifies the virtual item or the NPC that can perform interaction, and displays a corresponding special dotting control (corresponding to the foregoing object marking control) on the interface of the virtual scene. The player may perform dotting on the virtual item or the NPC by clicking/taping the special dotting control, and a target on which dotting is performed may have special representation in the virtual scene. Refer to FIG. 8. FIG. 8 is a schematic diagram of an interaction interface according to an embodiment of this application. As shown in part (a) in FIG. 8, when an NPC 801 exists near a point where the first virtual object controlled by the player reaches, the “NPC dotting” control 803 is displayed beside a “Dot” control 802, and the player may click/tap the “NPC dotting” control 803 to perform dotting. After the player performs dotting, a special marking style is displayed at a corresponding target (for example, the NPC 801) in the virtual scene (for example, an “arrow shape” element is added to the NPC 801). As shown in part (b) in FIG. 8, after the player performs dotting, the “NPC dotting” control 803 is changed to a “Cancel dotting” control 804, and the player may click/tap the “Cancel dotting” control 804 to cancel special dotting.

Based on the solution shown in any one or more of the foregoing embodiments of this application, in some embodiments, the foregoing operation 230al may be implemented as operation 230a1-1.

Operation 230a1-1: Display an object marking control on an interface of the virtual scene in response to that the first terminal is in the path recording mode and an interactive object exists in a specified range around the first virtual object, the interactive object being a virtual object having a function of performing interaction with the first virtual object.

In one embodiment, when the first terminal is in the path recording mode and the interactive object exists in the specified range around the first virtual object, for example, the interactive virtual item or NPC, the first terminal displays the object marking control, for example, the “NPC dotting” control 803 in FIG. 8, to the player.

Interaction between the interactive object and the first virtual object includes: dialog, quest turn-in, virtual item buying and selling, attacking/being attacked, and the like. There may be one interactive object or a plurality of interactive objects in the specified range around the first virtual object.

One embodiment provides a special display solution of an object marking control. The object marking control is used by the first terminal to mark the interactive object in the specified range of the first virtual object, to meet a requirement of the player for recording information such as a position of the interactive virtual item or NPC, and improve interaction efficiency between players. When the interactive object exists, the object marking control is displayed; and when the interactive object does not exist, the object marking control may not be displayed. In this case, conciseness of interface display is ensured, and an interface display effect is improved.

Based on the solution shown in any one or more of the foregoing embodiments of this application, in some embodiments, the foregoing operation 230a2 may be implemented as operation 230a2-1.

Operation 230a2-1: Perform position marking on the first virtual object in response to receiving a trigger operation on an object marking control, to obtain second marking information corresponding to a target interactive object, the target interactive object being one interactive object in the specified range around the first virtual object.

In one embodiment, when the first terminal receives the trigger operation performed by the player on the object marking control, the first terminal performs position marking on the first virtual object, to obtain the second marking information corresponding to the target interactive object.

If a plurality of interactive objects exists in the specified range around the first virtual object, the player may select one of the interactive objects to perform marking, or may sequentially mark the plurality of interactive objects.

Correspondingly, if only one interactive object exists in the specified range around the first virtual object, after the player triggers the object marking control, the player may directly mark the interactive object.

For example, the first terminal may display, on the interface of the virtual scene, a marking control that can be used by the player to select all current interactive objects with one click/tap, to improve user experience.

One embodiment provides an interactive object marking solution, to enable the player to mark the interactive object in the specified range where the first virtual object controlled by the player is located, thereby further improving interaction efficiency between players.

Based on the solution shown in any one or more of the foregoing embodiments of this application, in some embodiments, the method in the foregoing embodiments further includes the following operation:
adding a marking element to the target interactive object.

In one embodiment, the first terminal may add the marking element for distinguishing to the target interactive object.

The marking element may be a shape, a color, or the like that can be easily found.

As shown in FIG. 8, the “arrow shape” element may be added to a marked NPC 801.

In one embodiment, a special marking element is added to the target interactive object, so that a player can clearly distinguish the target interactive object marked by the player from a common target interactive object.

Based on the solution shown in any one or more of the foregoing embodiments of this application, in some embodiments, the method in the foregoing embodiments further includes the following operation:
switching, in response to receiving the trigger operation on the object marking control, the object marking control to a first canceling marking control for display; and canceling, in response to receiving a trigger operation on the canceling marking control, the second marking information corresponding to the target interactive object.

In one embodiment, when the first terminal receives the trigger operation performed by the player on the object marking control, the object marking control is switched to the first canceling marking control in the virtual interface.

The first canceling marking control may be a “Cancel dotting” control 804 shown in FIG. 8.

When the first terminal receives the trigger operation performed by the player on the canceling marking control, the first terminal cancels the second marking information corresponding to the target interactive object. In other words, when the player clicks/taps the “Cancel dotting” control 804 shown in FIG. 8, marking information corresponding to such dotting is deleted.

One embodiment provides a solution for canceling the second marking information corresponding to the target interactive object. When a player wants to delete marking information of a specific target interactive object, the player may click/tap a related cancel control on the virtual interface, to cancel the marking information of the target interactive object. In this solution, a cancel option of the second marking information corresponding to the target interactive object is additionally added, so that the player can flexibly control added marking information, thereby improving interaction efficiency between players.

Based on the solution shown in any one or more of the foregoing embodiments of this application, in some embodiments, the foregoing operation 230a2-1 may be implemented as:
Perform position marking on the first virtual object in response to receiving the trigger operation on the object marking control after receiving a selection operation on the target interactive object, to obtain the second marking information corresponding to the target interactive object; or
set, in response to receiving the trigger operation on the object marking control, the interactive object in the specified range around the first virtual object to a to-be-selected state; and perform position marking on the first virtual object in response to receiving the selection operation on the target interactive object, to obtain the second marking information corresponding to the target interactive object.

In one embodiment, the first terminal first receives the selection operation of the player on the target interactive object, and then receives the trigger operation of the player on the object marking control. The first terminal performs position marking on the first virtual object, and obtains the second marking information corresponding to the target interactive object. In other words, the player may first select the interactive object, and then perform a click/tap operation of marking.

In one embodiment, when receiving the trigger operation on the object marking control, the first terminal sets the interactive object in the specified range around the first virtual object to the to-be-selected state. When receiving the selection operation of the player on the target interactive object, the first terminal performs position marking on the first virtual object, to obtain the second marking information corresponding to the target interactive object. In other words, the player may first implement a click/tap operation of marking, to change a plurality of interactive objects in the specified range around the first virtual object to the to-be-selected state, and then select one or more interactive objects for marking.

One embodiment provides a plurality of example solutions for marking the target interactive object, which can improve efficiency and smoothness of a player in marking an interactive object.

Based on the solution shown in any one or more of the foregoing embodiments of this application, in some embodiments, the foregoing operation 230a1-1 may be implemented as: Respectively display, in response to that the first terminal is in the path recording mode and the interactive object exists in the specified range around the first virtual object, an object marking control corresponding to each interactive object.

In one embodiment, after the first terminal enters the path recording mode, when the interactive object exists in the specified range around the first virtual object, object marking controls respectively corresponding to one or more interactive objects in the designated range are displayed on the virtual interface.

One embodiment provides a display solution of an object marking control, including displaying the corresponding object marking control for each interactive object in the specified range, to facilitate a player in selectively marking an interactive object.

The foregoing operation 230a2-1 may be implemented as: Perform position marking on the first virtual object in response to receiving a trigger operation on an object marking control corresponding to the target interactive object, to obtain the second marking information corresponding to the target interactive object.

In one embodiment, the player may click/tap an object marking control corresponding to an interactive object. When the first terminal receives the trigger operation performed by the player on the object marking control corresponding to the target interactive object, the first terminal performs position marking on the first virtual object, to obtain the second marking information corresponding to the target interactive object.

Based on the solution in any one or more of the foregoing embodiments of this application, in some embodiments, the second marking information corresponding to the target interactive object further includes object information of the target interactive object.

In one embodiment, the foregoing second marking information corresponding to the target interactive object further includes the object information of the target interactive object, such as an identity or a dialog of the target interactive object.

In one embodiment, the object information of the target interactive object is added to the second marking information corresponding to the target interactive object, to facilitate the player in viewing the marked target interactive object.

Based on the solution shown in any one or more of the foregoing embodiments of this application, in some embodiments, the method in the foregoing embodiment shown in FIG. 7 further includes:

Operation 230a3: Obtain, in response to receiving a remark operation on the second marking information, remark information corresponding to the remark operation; and add the remark information to the second marking information.

For example, the player may perform remarking on a marked position, to share remark content together when sharing a path.

In one embodiment, the player clicks/taps a related control on the virtual interface, to perform remarking on the second marking information. After receiving the remark operation performed by the player on the second marking information, the first terminal displays, on the virtual interface, an interface configured to input remark information. After the player inputs the remark information, the first terminal obtains the remark information inputted by the player, and adds the remark information to the second marking information, for subsequent generation of the guidance information.

Correspondingly, the player may alternatively add remark information to the first marking information. Details are not described herein again.

One embodiment provides a solution that facilitates a player in adding remark information, including: when the player performs the remark operation, obtaining and adding the related remark information to the second marking information. In this solution, information instantly remarked by the player can be added to corresponding marking information, thereby improving sharing efficiency of the player, and enriching fun and functions of a virtual game.

Based on the solution shown in any one or more of the foregoing embodiments of this application, in some embodiments, the method in the foregoing embodiment shown in FIG. 7 further includes:

Operation 230a4: Cancel the second marking information in response to receiving a cancellation operation on the second marking information.

For example, the player may cancel the second marking information, to delete redundant marking information.

Correspondingly, the player may cancel the first marking information, and details are not described herein again.

In one embodiment, the first terminal receives the cancellation operation performed by the player on the second marking information, and cancels the corresponding second marking information from a record. The canceling the second marking information may refer to deleting the second marking information, or moving the second marking information to a specified position.

One embodiment provides a solution for canceling the second marking information. When a player wants to delete specific marking information, the player may click/tap a related cancel control on the virtual interface, to cancel the marking information. In this solution, a cancel option of the second marking information is additionally added, so that the player can flexibly control added marking information, thereby improving interaction efficiency between players.

Based on the solution shown in any one or more of the foregoing embodiments of this application, in some embodiments, the interface of the virtual scene includes a second canceling marking control, and the foregoing operation 230a4 may be implemented as: Cancel one piece of most recently obtained second marking information in response to receiving a trigger operation on the second canceling marking control.

In one embodiment, the first terminal may display, on the interface of the virtual scene, the second canceling marking control configured to cancel the second marking information. When receiving the triggering performed by the player on the second canceling marking control, the piece of most recently obtained second marking information is canceled.

The most recently refers to being closest in time. The player may alternatively perform continuous clicking/taping, to sequentially delete pieces of currently recently obtained second marking information.

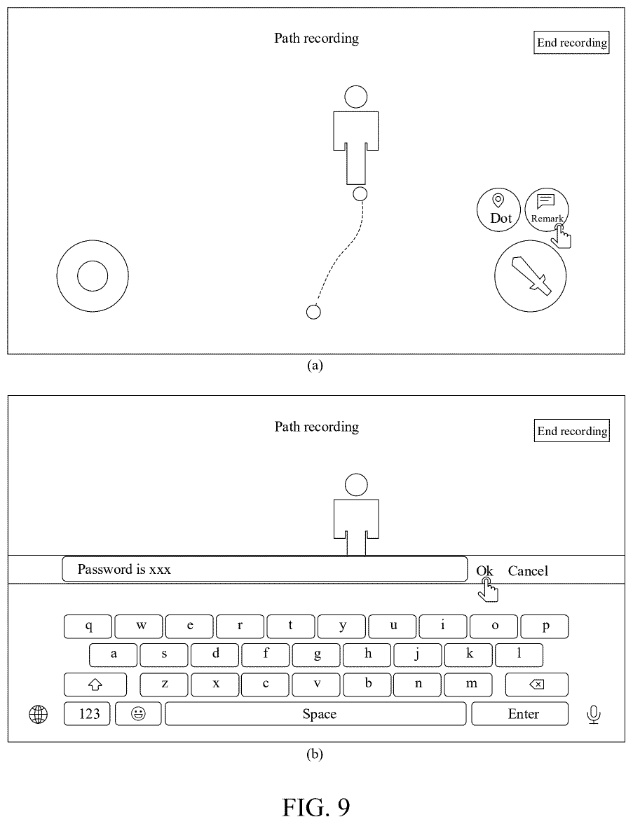

Refer to FIG. 9. FIG. 9 is a schematic diagram of a remark interface according to an embodiment of this application. As shown in part (a) in FIG. 9, a player may click/tap “Remark” at a position on which dotting is performed, to fill in a remark. As shown in part (b) in FIG. 9, for example, a quest point needs to be decrypted, and a decryption password thereof is 513, then the player may remark information “Password is 513” to the point. After inputting remark content, the player may click/tap “Ok” to save the remark information. The remark information is applied to a point closest to the current position, and the remark information is automatically displayed in a subsequently generated quest item.

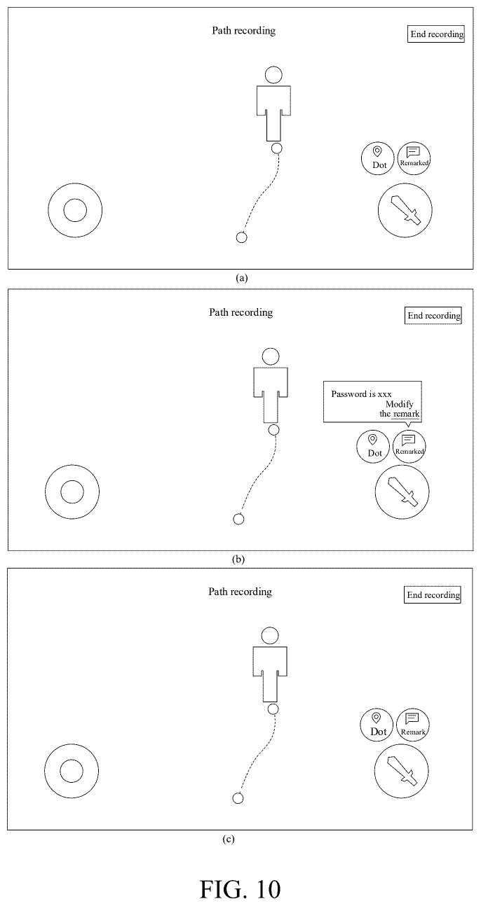

Refer to FIG. 10. FIG. 10 is a schematic diagram of a remarked interface according to an embodiment of this application. As shown in part (a) in FIG. 10, after the player saves the remark information at a specific point, when the first virtual object approaches the point, the “Remark” control in part (a) in FIG. 9 is displayed in a “Remarked” style. As shown in part (b) in FIG. 10, the player clicks/taps a “Remarked” control, to view details of the remark content, or modify the remark content. The player may click/tap a “Modify the remark” control, and a remark input interface shown in part (b) in FIG. 9 pops up on the virtual interface of the first terminal. After deletion is performed on the remark content, the remark content may be deleted by clicking/taping “Ok”. As shown in part (c) in FIG. 10, if the player deletes the remark content, the control is restored to the “Remark” style.

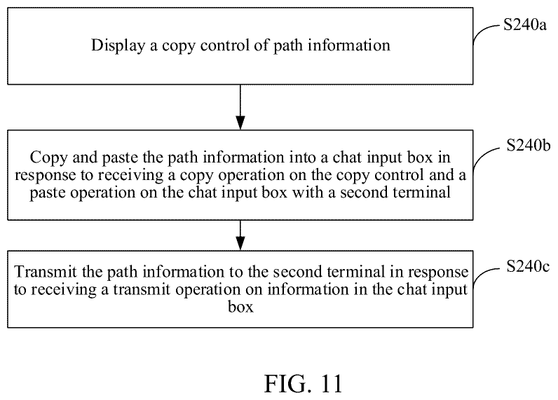

Based on the solution shown in any one or more of the foregoing embodiments of this application, specifically, for example, based on the solution in the embodiments shown in FIG. 2, FIG. 3, and FIG. 4, refer to FIG. 11. FIG. 11 is a flowchart of a path processing method in a virtual scene according to yet another embodiment of this application. The method is performed by a computer device. In one embodiment, the computer device may be the first terminal 110 or the second terminal 130 in the system shown in FIG. 1. As shown in FIG. 11, the foregoing operation 240 may be implemented as operation 240a, operation 240b, and operation 240c.

Operation 240a: Display a copy control of path information. For example, the copy control is displayed on the interface of the virtual scene.

Operation 240b: Copy and paste the path information into a chat input box in response to receiving a copy operation on the copy control and a paste operation on the chat input box with a second terminal.

Operation 240c: Transmit the path information to the second terminal in response to receiving a transmit operation on information in the chat input box.

In one embodiment, on the interface of the virtual scene, the first terminal displays the copy control of the path information to the player. The player clicks/taps the copy control to share specific content that represents the path information.

When the first terminal receives the copy operation of the player on the copy control, and the player pastes the copied specific content into the chat input box with the second terminal, the first terminal copies and pastes the path information into the chat input box, so that the player of the second terminal can view the path information.

One embodiment provides a path information transmitting solution, including displaying a copy control on a virtual interface, where a player may click/tap the copy control and open a chat input box with a friend, and transmit specific content of the copy control to the friend. This solution adds a specific solution of transmitting path information, so that the player can share the path information inside a virtual game.

Based on the solution shown in any one or more of the foregoing embodiments of this application, in some embodiments, the method in the embodiments shown in FIG. 3 and FIG. 4 further includes: displaying an end recording control on the interface of the virtual scene in response to that the first terminal is in the path recording mode. The foregoing operation 230b may be implemented as: In response to receiving a trigger operation on the end recording control, control the first terminal to exit the path recording mode, and obtain the path information.

In one embodiment, after the first terminal enters the path recording mode, the end recording control configured to end the path recording mode is displayed on the interface of the virtual scene. The player may turn off the path recording mode by clicking/taping the end recording control. When the first terminal receives triggering performed by the player on the end recording control, the first terminal is controlled to exit the path recording mode, and the path information marked by the player is obtained.

One embodiment provides an operation solution of exiting the path recording mode, including displaying the end recording control on the virtual interface, and the player may click/tap the end recording control to turn off the path recording mode. This solution complements an exit solution of the path recording mode, and can ensure interaction efficiency of the path recording mode.

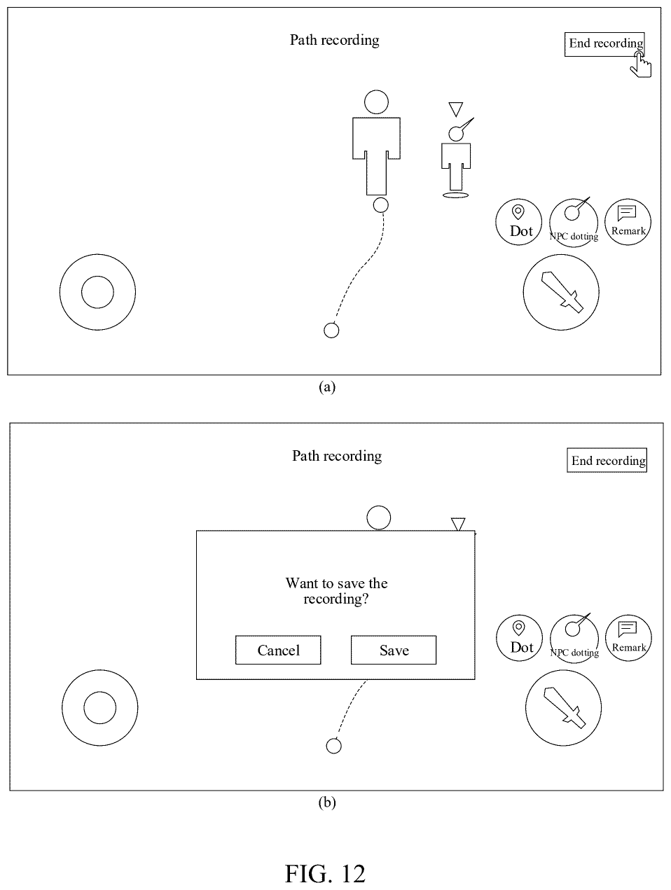

Refer to FIG. 12. FIG. 12 is a schematic diagram of an end recording interface according to an embodiment of this application. As shown in part (a) in FIG. 12, after completing recording, the player may click/tap an “End recording” control, to end the current path recording mode. The player may choose to save or delete this segment of recording. As shown in part (b) in FIG. 12, after the player clicks/taps the “End recording” control, a pop-up window is displayed on the virtual interface to prompt whether to save the recording. The player can generate path recording of the first virtual object by choosing “Save”.

After the player chooses to save the recording, one piece of recording is generated. The player may choose to delete the recording, or copy the recording and transmit the recording to a friend by clicking/taping Copy code, and there is a prompt indicating the player that code has been copied.

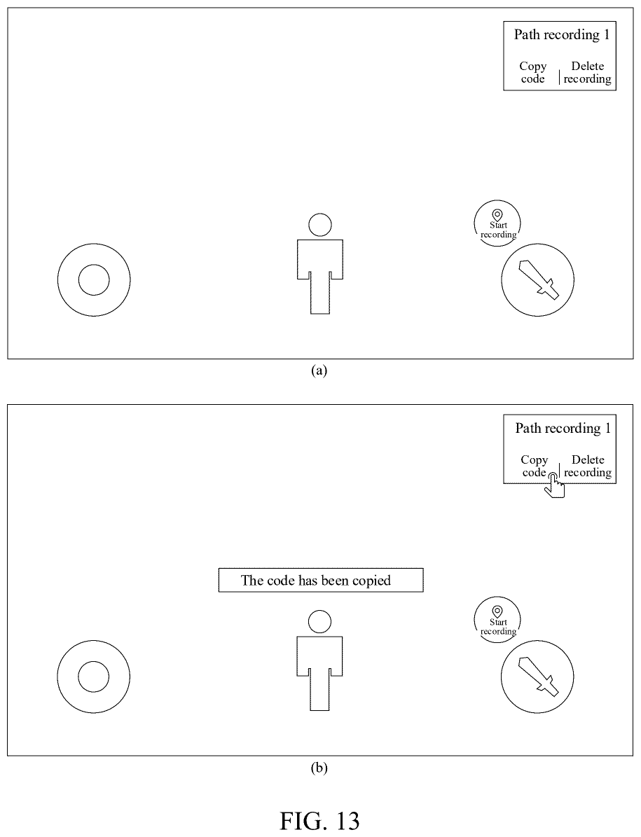

Refer to FIG. 13. FIG. 13 is a schematic diagram of a path information interface according to an embodiment of this application. As shown in part (a) in FIG. 13, a player may perform code copying or recording deleting. As shown in part (b) in FIG. 13, after the player clicks/taps “Copy code”, the virtual interface prompts “The code has been copied”, and the player may share the recorded path information to a friend by pasting the code.

The player enters a chat box, selects a friend, and then may copy and paste the code to the friend. After the code is transmitted to the friend, a client of the chat box identifies the transmitted code, and automatically generates a piece of quest guidance information to the friend. When the friend clicks/taps to generate a quest, a corresponding guidance quest is generated in a quest tracker.

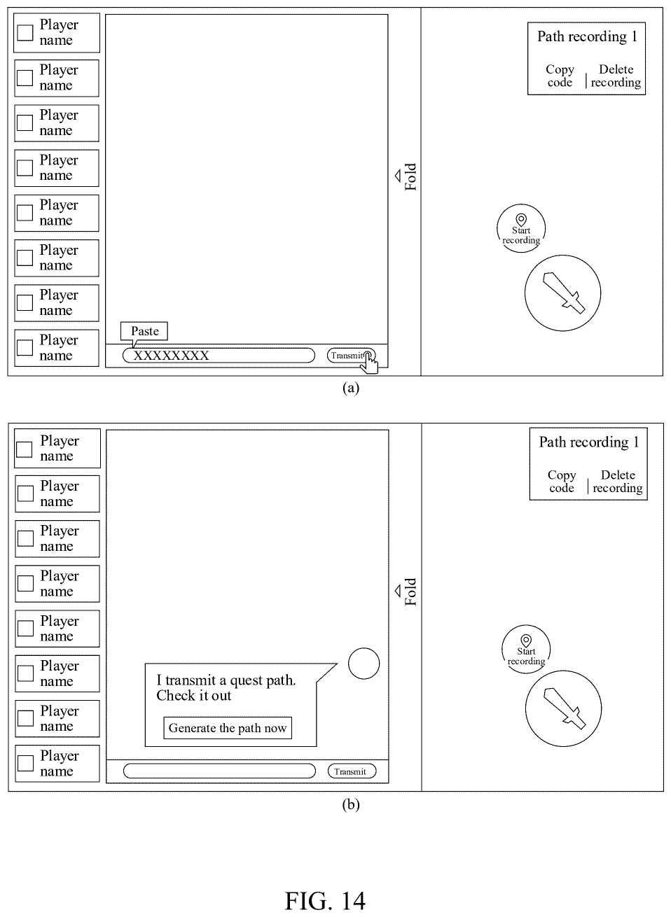

Refer to FIG. 14. FIG. 14 is a schematic diagram of a sharing interface according to an embodiment of this application. As shown in part (a) in FIG. 14, a player pastes code, and transmits information to a friend. As shown in part (b) in FIG. 14, a system identifies content as quest path code, and automatically generates a path quest message.

This application aims to resolve a problem that quest points/photography points in a game cannot form a complete link, and sets a path point recording mode. After entering the mode, a player may record each path point, and may additionally mark a special element near the path point. For example, if there is an NPC character that needs a dialog at the path point, the player may additionally mark the NPC. After a plurality of points are marked, a complete quest path is automatically generated. The player may share the path with another player. Another player may generate a corresponding quest section link based on the shared link, and the quest section link automatically guides the another player to a corresponding area.

Based on the solution shown in any one or more of the foregoing embodiments of this application, in some embodiments, the foregoing operation 250 in FIG. 2 may be implemented as:

Operation 250a: The second terminal obtains quest text based on the path information in response to receiving a quest path generation operation.

A generation procedure of the quest text may be implemented as the following operations:
A client transmits the corresponding path information to a back-end tool of a server;
The back-end tool of the server performs processing on the path information, including performing processing on information such as the first marking information, the second marking information, and the remark information, to generate the corresponding quest text; and
The server transmits the quest text to the client.

For example, quest text generation is when the client transmits corresponding information elements to the tool that is of the server and that is linked to a back end. The back-end tool performs secondary text processing, for example, inputting position coordinate information “xx, xx”, “NPC xx”, and “Need xx item” to the back end, with an additional description “Connect the element information to form a complete quest text introduction”. After receiving the information, the back end generates corresponding text information via back-end AI, and feeds back the corresponding text information to the server. The server transmits the corresponding information to the client, to generate the corresponding quest text.

Operation 250b: The second terminal presents guidance information of a target path on an interface of the virtual scene based on the quest text.

If the path information includes special element information (for example, marking information of the foregoing interactive object), the second terminal displays a corresponding special marking style (for example, a marking element of the foregoing interactive object) on the interface of the virtual scene.

If the remark information exists in the path information, the second terminal displays the corresponding remark content on the interface of the virtual scene, so that the player of the second terminal can complete a related quest based on the guidance information.

Based on the solution shown in any one or more of the foregoing embodiments of this application, in some embodiments, the foregoing operation 260 in FIG. 2 may be implemented as:

Operation 260a1: The second terminal displays, on the interface of the virtual scene in response to receiving a trigger operation on the guidance information, a first piece of marking information, and guidance content corresponding to a second piece of marking information.

The player of the second terminal clicks/taps a guidance sign corresponding to a next piece of marking information, the corresponding virtual object moves to a position corresponding to the next piece of marking information, and at the same time, the displayed content and content such as a displayed mark of an NPC and a displayed remark are updated.

The quest path is for path guidance. The path guidance may choose to use an original path of the player, or may choose an optimized path mode.

If the player chooses an optimized path, in the optimized path mode, the client transmits a corresponding path node to the server, and the server determines a closest path between nodes and feeds back the path to the client. Path guidance is performed for the player through the shortest path.

Operation 260a2: The second terminal displays, on the interface of the virtual scene in response to receiving a trigger operation on the second piece of marking information, the second piece of marking information, and guidance content corresponding to a third piece of marking information.

The rest can be deduced by analogy, until the player of the second terminal completes the guidance quest, or exits the guidance quest.

Based on the solution shown in any one or more of the foregoing embodiments of this application, in some embodiments, the foregoing operation 260 in FIG. 2 may be implemented as:

Operation 260b1: The second terminal displays a guidance information overview on the interface of the virtual scene.

The player of the second terminal may randomly click/tap and view one piece of guidance information in the guidance information overview.

Operation 260b2: In response to receiving a trigger operation on first guidance information, the second terminal controls a second virtual object to move to a position corresponding to the first guidance information, and displays quest content corresponding to the first guidance information, a prompt of second guidance information, and a prompt of second guidance information.

The first guidance information is a piece of guidance information in the guidance information overview, the second guidance information is a previous piece of guidance information of the first guidance information, and the second guidance information is a next piece of guidance information of the first guidance information.

That is, when viewing one piece of guidance information in the guidance information overview, the player of the second terminal may also view a previous piece of guidance information and a next piece of guidance information that are of the guidance information.

The player of the second terminal may click/tap and view the second guidance information and the second guidance information.

Operation 260b3: The second terminal displays the guidance information overview on the interface of the virtual scene in response to receiving an overview operation on guidance information.

The player of the second terminal may randomly click/tap and view one piece of guidance information in the guidance information overview again.

For guidance information that has been triggered, a special element is added to the complete guidance information overview, for example, a “Finished” style is added.

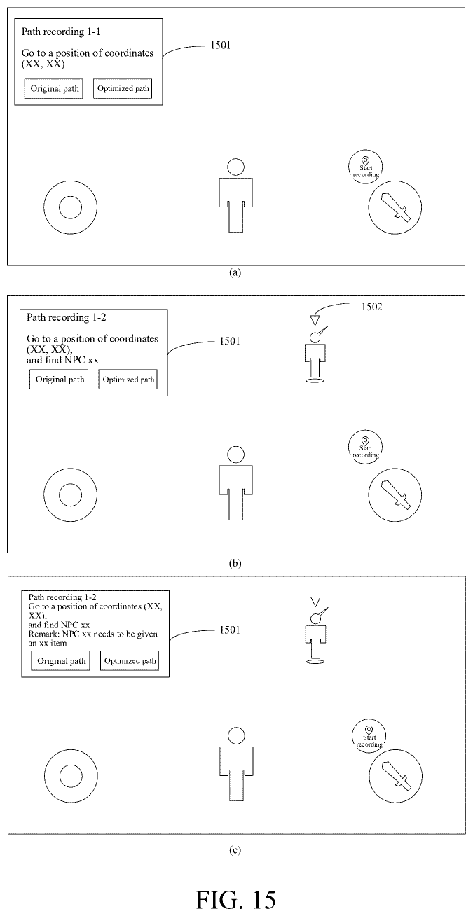

Refer to FIG. 15. FIG. 15 is a schematic diagram of a path guiding interface according to an embodiment of this application.

1. After the player of the second terminal (a sharing object of the player of the first terminal) clicks/taps to generate a path, the corresponding path is generated in the quest tracker, and text is automatically generated by the back-end tool. The player of the second terminal may choose to move through the original path (namely, a path that the player actually walks through during recording) or the optimized path (a shortest distance path calculated by a system). As shown in part (a) in FIG. 15, content automatically supplemented by the back-end tool is displayed in a quest tracker 1501.

2. After the player of the second terminal reaches a corresponding position, a next guiding path quest is triggered, and a title stage is changed. As shown in part (b) in FIG. 15, if a mark of an NPC or another interactive element exists at this stage, corresponding information is generated in the text, and is displayed in the quest tracker 1501. In addition, currently, the player of the second terminal can also see a marked style 1502 of the corresponding NPC/special interactive element in the virtual scene.

3. As shown in part (c) in FIG. 15, if there is remark information at a current point, a corresponding remark information annotation is generated for the quest. For example, if the player of the first terminal remarks that “NPC xx needs to be given an xx item”, a remark of “NPC xx needs to be given an xx item” is automatically generated in the text and is displayed in the quest tracker 1501.

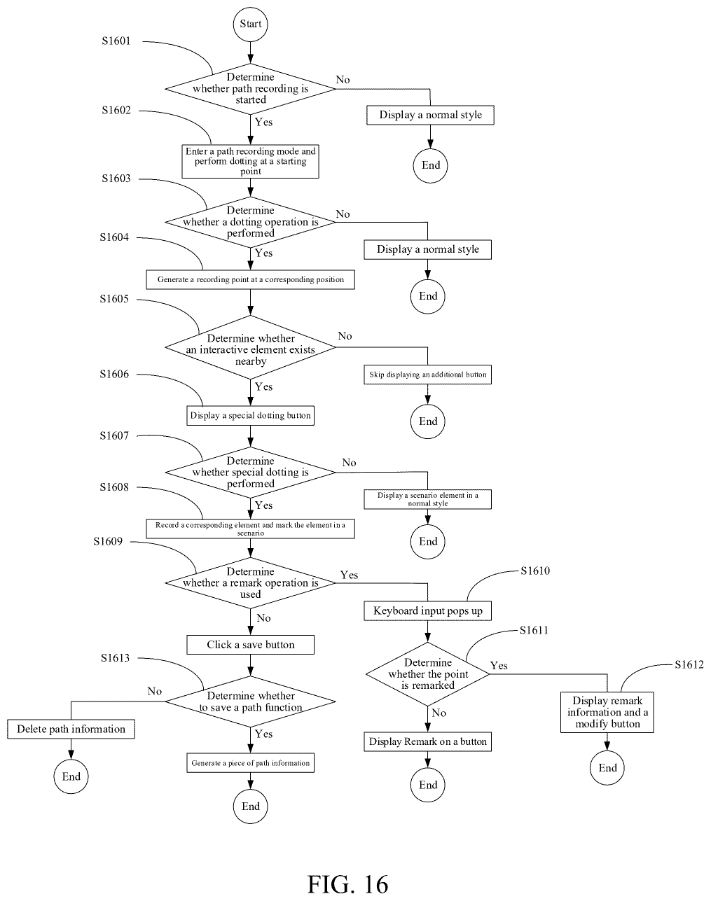

Based on the solution shown in any one or more of the foregoing embodiments of this application, refer to FIG. 16. FIG. 16 is a flowchart of path recording according to an embodiment of this application. As shown in FIG. 16, a path recording procedure of a virtual object is as follows:

S1601: A client determines whether a player starts path recording, in other words, whether the player clicks/taps the “Start recording” control 302 shown in FIG. 3.

S1602: The player clicks/taps the “Start recording” control, to enter a path recording mode; a virtual interface displays a “Dot” control and a “Remark” control, and the top displays a “Path recording” style; and the client automatically performs dotting in an initial standing position, and a path line is recorded when the player controls a virtual object to walk; or if the player does not click/tap the “Start recording” control, the virtual interface displays a normal style.

S1603: The client determines whether the player performs a dotting operation, in other words, whether the player clicks/taps the “Dot” control 403 shown in FIG. 4.

S1604: After the player clicks/taps the “Dot” control, the client generates a recording point at a corresponding position, and displays the recording point on the virtual interface; or if the player does not click/tap the “Dot” control, the virtual interface displays the normal style.

S1605: The client determines whether an interactive element or a special markable element, such as an NPC or an interactive virtual item, exists around a current position of the virtual object controlled by the player.

S1606: If the special element exists, display a special element marking control, and the player may mark the element by clicking/taping the control; if a plurality of special markable elements exist, determine display priorities based on a distance to the current position; or if no special element exists, display only the “Dot” control and skip displaying an additional special Dot control.

S1607: The client determines whether the player performs special dotting, in other words, determines whether an element on which the special dotting is performed exists within a range of a current scenario.

S1608: If the element on which the special dotting is performed, and mark the element in the virtual scene: The client feeds back corresponding information to a server, and the server feeds back the corresponding information element; the client displays the corresponding element in the virtual scene in a special marking style, and the client displays a corresponding control in a “Cancel marking” style; and the player may cancel marking of the special element by clicking/taping the “Cancel marking” control; or if no special element exists, display a corresponding element in the virtual scene in a normal style.

S1609: The client determines whether the player uses a remark operation, in other words, determines whether the player clicks/taps the “Remark” control shown in FIG. 9.

S1610: If the player clicks/taps the “Remark” control, keyboard input pops up on the virtual interface, and the player may input remark information, to add a remark to a point closest to the player; or if the player does not click/tap the remark control, there is no remark information.

S1611: The client determines whether the point is remarked, in other words, determines whether the remark information exists at the current point of the virtual object controlled by the player.

S1612: If the remark information exists, the virtual interface displays the remark information and a modify control; the client transmits a message that the remark information exists at the point to the server; the server feeds back data of the corresponding remark information to the client; the remark control corresponding to the client changes to a “Remarked” style; and the player may view or modify remarked information by clicking/taping a “Remarked” control; or if no remark information exists, display the control in a normal style of “Remark”.

S1613: After the player clicks/taps a save control, the client determines whether to save a path function; and if the player clicks/taps the “Save” control shown in FIG. 12, the client generates a piece of path information; or if the player clicks/taps the “Delete recording” control shown in FIG. 13, the client deletes the corresponding path information.

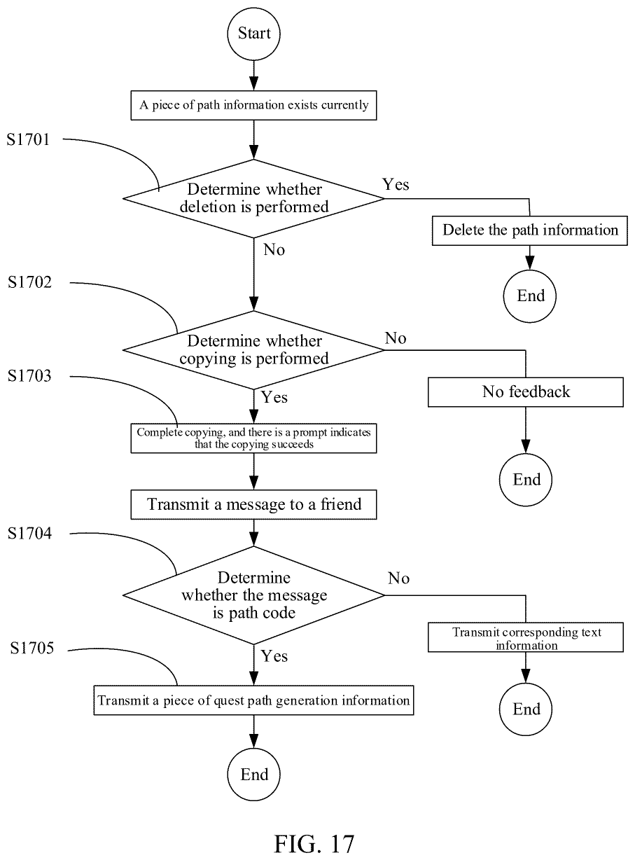

Based on the solution shown in any one or more of the foregoing embodiments of this application, refer to FIG. 17. FIG. 17 is a flowchart of sending path information according to an embodiment of this application.

S1701: If a piece of path information currently exists, a client determines whether deletion is performed, in other words, whether a player clicks/taps the “Delete recording” control shown in FIG. 13.

S1702: If the player does not click/tap the “Delete recording” control, the client determines whether copying is performed, in other words, whether the player clicks/taps the “Copy code” control shown in FIG. 13; and if the player clicks/taps the “Delete recording” control, the client deletes the corresponding path information.

S1703: If the player clicks/taps the “Copy code” control, the client completes copying, and there is a prompt on a virtual interface indicating that the copying succeeds.

S1704: When the player transmits a message to a friend, the client determines whether information transmitted by the player is path code: The client transmits the information to a server, and the server determines whether the information is path code information.

S1705: If the information is the path code information, the server feeds back the information to the client, and automatically generates a piece of quest path generation information, and the player can click/tap transmit to generate a corresponding path quest; or if the information is not the path code information, directly transmit the text information, and perform no special determining.

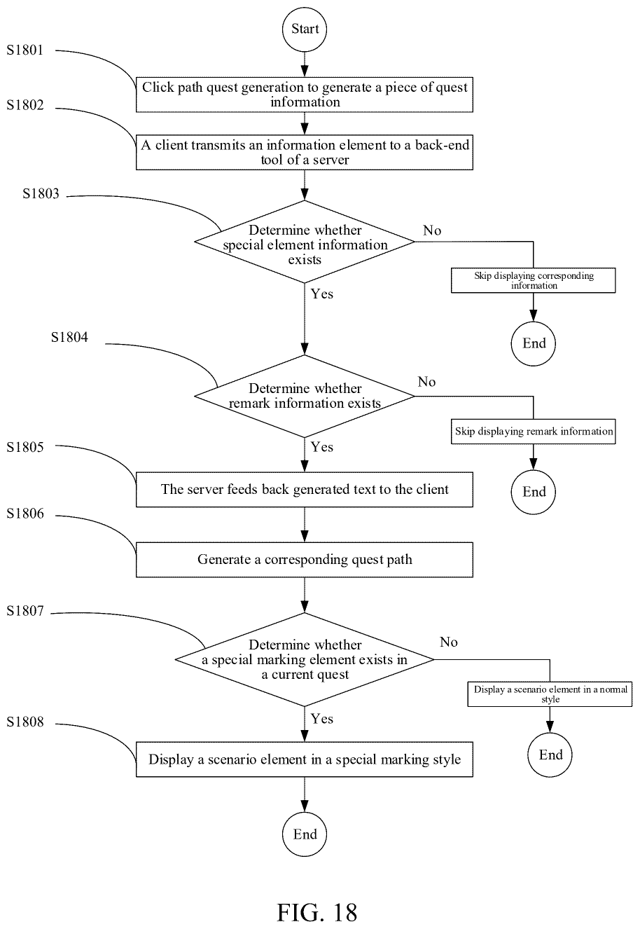

Based on the solution shown in any one or more of the foregoing embodiments of this application, refer to FIG. 18. FIG. 18 is a flowchart of generating a path task according to an embodiment of this application.

S1801: A player that receives a path quest may click/tap path quest generation, to generate a piece of quest information.

S1802: A client transmits an information element to a back-end tool of a server.

S1803: The client determines whether special element information exists; and if the special element information exists, display the corresponding information; or if no special element information exists, skip displaying the corresponding information.

S1804: The client determines whether remark information exists; and if the remark information exists, display the remark information; or if no remark information exists, skip displaying the remark information.

S1805: The server feeds back generated text to the client.

S1806: Generate a corresponding quest path and quest text;

S1807: The client determines whether a special marking element exists in a current quest.

S1808: If the special marking element exists, display a scenario element in a special marking style; or if no special marking element exists, display the scenario element in a normal style.

The task path is used for path guidance. The path guidance may choose to use an original path of the player, or may choose to optimize a path mode. If the player chooses to optimize a path, in an optimized path mode, the client sends a corresponding path node to the server end, and the server end determines a closest path between nodes and feeds back the path to the client. The player performs path guidance by using a shortest path.

In existing MMO and open-world games, there are usually some special multi-section quests, and the quests require players to search for hidden places. If the players want to help each other, the players can only transmit position coordinates to friends one by one, or view operations by searching for a strategy, which is inconvenient. When the players want to shoot a video of the players walking on a same path or arrive at several specific places for photography, a player needs to arrive at each place and then call other players, which is also inconvenient.

This application aims to provide a convenient recording manner, where recording can be performed at each quest node position, place coordinates or an NPC corresponding to a place can be marked, and after an entire link is marked, a quest chain is generated via back-end AI. In the quest chain, quest text is automatically generated, and attached with corresponding node coordinates, and a player can rapidly complete a corresponding quest by using coordinate guidance of the quest of stages. In addition, a plurality of segments of path marking are also very useful for the player to shoot a related video in a specific segment of path, and the player can complete an operation like riding in the same path without following and adjustment. A quest item therein is automatically generated by an artificial intelligence text generation tool.

This application resolves a problem that in MMO and open-world games, in an existing environment, strategy guidance of a multi-section quest is only single-point guidance and can only be manually inputted, and provides a function of sharing, in the games, path point sections that can directly perform guidance. The function may be applied to guidance of a complex quest with sections, or video shooting on a specific segment of path or photographing at a plurality of points by players.

This solution is not limited to single position determining, and clothes try-on change within an area range is also included in the solution, to be specific, when the player enters a specific area, a clothes try-on effect is continuously displayed, and when the player leaves the area, original clothes display is restored.

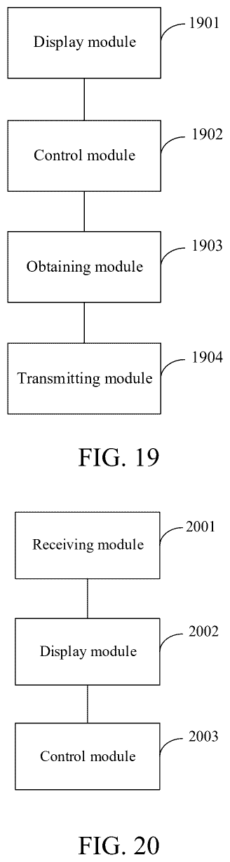

FIG. 19 is a block diagram of a path processing apparatus in a virtual scene according to an embodiment of this application. The apparatus includes:
a display module 1901, configured to display a virtual scene and a start recording control;
a control module 1902, configured to control, in response to receiving a trigger operation on the start recording control, a first terminal to enter a path recording mode;
an obtaining module 1903, configured to obtain, in response to that the first terminal is in the path recording mode and at least one marking operation is received, path information, the path information being used for indicating a target path, and the target path being a path formed by sequentially connecting an initial position to at least one marked position; the initial position being a position of a first virtual object when the first terminal enters the path recording mode, the marked position being a position of the first virtual object when the first terminal receives the marking operation, and the first virtual object being a virtual object controlled by the first terminal; and
a sending module 1904, configured to send the path information to a second terminal, the second terminal presenting guidance information of the target path based on the path information.

In some embodiments, the apparatus in FIG. 19 further includes a marking module, configured to:
perform, in response to that the first terminal enters the path recording mode, position marking on a first virtual object, to obtain first marking information, and the first marking information includes position information of an initial position;
the obtaining module 1903 is further configured to perform, in response to that the first terminal is in the path recording mode and the marking operation is received, position marking on the first virtual object, to obtain second marking information, and the second marking information includes position information of the marked position; and
obtain, in response to receiving a path information generation operation, the path information, and the path information is used for indicating the first marking information and one or more pieces of the second marking information.

In some embodiments, the obtaining module 1903 is further configured to: display a marking control in response to that the first terminal is in the path recording mode; and perform position marking on the first virtual object in response to receiving a trigger operation on the marking control, to obtain one piece of second marking information.

In some embodiments, the obtaining module 1903 is further configured to display, in response to that the first terminal is in the path recording mode and an interaction object exists in a specified range around the first virtual object, an object marking control, and the interaction object is a virtual object having a function of executing interaction with the first virtual object.

In some embodiments, the obtaining module 1903 is further configured to perform, in response to receiving a trigger operation on the object marking control, position marking on the first virtual object, to obtain second marking information corresponding to a target interaction object, and the target interaction object is one of interaction objects in the specified range around the first virtual object.

In some embodiments, the obtaining module 1903 is further configured to: perform position marking on the first virtual object in response to receiving the trigger operation on the object marking control after receiving a selection operation on the target interactive object, to obtain the second marking information corresponding to target interactive object; or set the interactive object in the specified range around the first virtual object to a to-be-selected state in response to receiving the trigger operation on the object marking control; and perform position marking on the first virtual object in response to receiving the selection operation on the target interactive object, to obtain the second marking information corresponding to the target interactive object.

In some embodiments, the obtaining module 1903 is further configured to: respectively display, in response to that the first terminal is in the path recording mode and the interactive object exists in the specified range around the first virtual object, an object marking control corresponding to each interactive object; and the performing position marking on the first virtual object in response to receiving the trigger operation on the object marking control, to obtain the second marking information corresponding to the target interactive object, includes: performing position marking on the first virtual object in response to receiving a trigger operation on an object marking control corresponding to the target interactive object, to obtain the second marking information corresponding to the target interactive object.

In some embodiments, the second marking information corresponding to the target interactive object further includes object information of the target interactive object.

In some embodiments, the apparatus in FIG. 19 further includes an adding module, configured to add a marking element to the target interactive object.

In some embodiments, the apparatus in FIG. 19 further includes: a first canceling module, configured to: switch, in response to receiving the trigger operation on the object marking control, the object marking control to a first canceling marking control for display; and cancel, in response to receiving a trigger operation on the canceling marking control, the second marking information corresponding to the target interactive object.

In some embodiments, the apparatus in FIG. 19 further includes: an adding module, configured to: obtain, in response to receiving a remark operation on the second marking information, remark information corresponding to the remark operation; and add the remark information to the second marking information.

In some embodiments, the apparatus in FIG. 19 further includes: the first canceling module, configured to cancel the second marking information in response to receiving a cancellation operation on the second marking information.

In some embodiments, the transmitting module 1904 is further configured to: display a copy control of the path information; copy and paste the path information into a chat input box in response to receiving a copy operation on the copy control and a paste operation on the chat input box with the second terminal; and transmit the path information to the second terminal in response to receiving a transmit operation on information in the chat input box.

In some embodiments, an end recording control is displayed in response to that the first terminal is in the path recording mode; and

The obtaining module 1903 is further configured to control, in response to receiving a trigger operation on the end recording control, the first terminal to exit the path recording mode, and obtain the path information.

FIG. 20 is a block diagram of a path processing apparatus in a virtual scene according to an embodiment of this application. The apparatus includes:

a receiving module 2001, configured to receive path information sent by a first terminal, the path information being obtained by the first terminal when the first terminal is in a path recording mode and receives at least one marking operation; the path information being used for indicating a target path, and the target path being a path formed by sequentially connecting an initial position to at least one marked position; the initial position being a position of a first virtual object when the first terminal enters the path recording mode, the marked position being a position of the first virtual object when the first terminal receives the marking operation, and the first virtual object being a virtual object controlled by the first terminal;
a presenting module 2002, configured to present, based on the path information, guidance information of the target path; and
a control module 2003, configured to control, in response to receiving a trigger operation on the guidance information, a second virtual object to move between the initial position and one or more marked positions in sequence.

When the apparatus provided in the foregoing embodiments implements functions of the apparatus, division of the foregoing function modules is merely used as an example for description. In some embodiments, the functions may be allocated to and completed by different function modules based on specific requirements. In other words, an internal structure of the device is divided into different function modules, to complete all or some of the foregoing described functions.

Specific manners of performing operations by various modules of the apparatus in the foregoing embodiments are described in detail in embodiments related to the methods, and technical effects achieved by the various modules in performing the operations are the same as those in the embodiments related to the methods. Details are not described herein again.

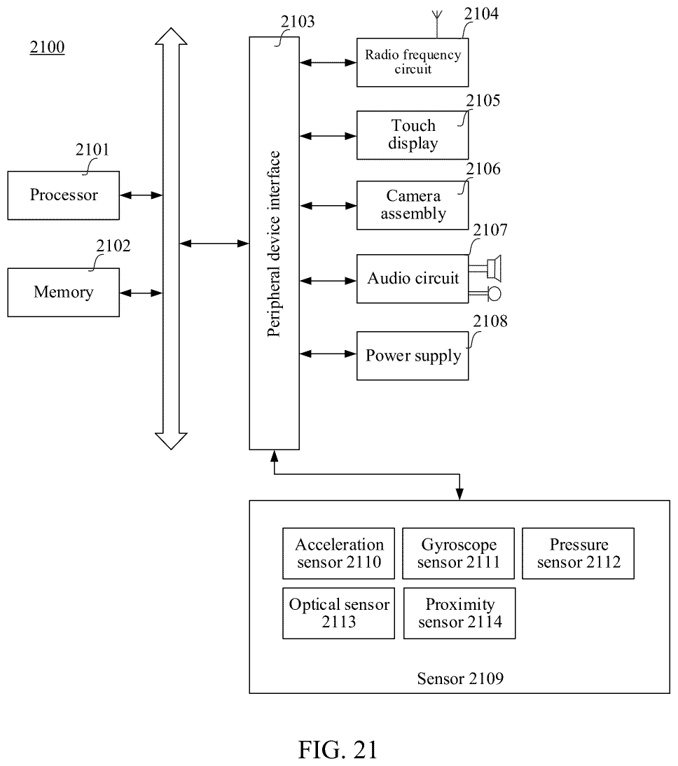

FIG. 21 is a structural block diagram of a computer device according to an embodiment of this application. The computer device 2100 may be a portable mobile terminal, for example, a smartphone, a tablet computer, a moving picture experts group audio layer III (MP3) player, or a moving picture experts group-4 part 14 (MP4) player. The computer device 2100 may be also referred to as another name such as user equipment or a portable terminal.

Generally, the computer device 2100 includes a processor 2101 and a memory 2102.

The memory 2102 may include one or more computer-readable storage media. The computer-readable storage medium may be tangible and non-transitory. The memory 2102 may further include a high-speed random access memory and a non-volatile memory, for example, one or more disk storage devices or flash storage devices. In some embodiments, the non-transitory computer-readable storage medium in the memory 2102 is configured to store at least one instruction. The at least one instruction is executed by the processor 2101, to implement the path processing method in a virtual scene provided in the embodiments of this application.

In some embodiments, the computer device 2100 may further include, for example, a peripheral device interface 2103 and at least one peripheral device. Specifically, the peripheral device includes: at least one of a radio frequency circuit 2104, a touch display 2105, a camera 2106, an audio circuit 2107, and a power supply 2108.

In some embodiments, the computer device 2100 further includes one or more sensors 2109. The one or more sensors 2109 include, but are not limited to: an acceleration sensor 2110, a gyroscope sensor 2111, a pressure sensor 2112, an optical sensor 2113, and a proximity sensor 2114.

A person skilled in the art may understand that the foregoing shown structure constitutes no limitation on the computer device 2100, and the computer device 2100 may include more or fewer components than those shown in the figure, or some components may be combined, or a different component deployment may be adopted.

In one embodiment, a chip is further provided. The chip includes a programmable logic circuit and/or program instructions. When running on a computer device, the chip is configured to implement the path processing method in a virtual scene according to the foregoing aspects.

In one embodiment, a computer program product is further provided. The computer program product includes computer instructions, and the computer instructions are stored in a computer-readable storage medium. A processor of a computer device reads the computer instructions from the computer-readable storage medium, and the processor reads and executes the computer instructions from the computer-readable storage medium, to implement the path processing method in a virtual scene provided in the foregoing method embodiments.

In one embodiment, a computer-readable storage medium is further provided. The computer-readable storage medium has a computer program stored therein, and the computer program is loaded and performed by a processor, to implement the path processing method in a virtual scene provided in the foregoing method embodiments.

What is claimed is:

1. A path processing method in a virtual scene, the method being performed by a first terminal and comprising:
displaying the virtual scene and a start recording control;
controlling the first terminal to enter a path recording mode in response to receiving a trigger operation on the start recording control;
obtaining path information in response to that the first terminal is in the path recording mode and receives at least one marking operation, and the target path being a path formed by sequentially connecting an initial position to at least one marked position, the path information being configured for indicating a target path, the initial position being a position of a first virtual object when the first terminal enters the path recording mode, the marked position being a position of the first virtual object when the first terminal receives the marking operation, and the first virtual object being controlled by the first terminal; and
transmitting the path information to a second terminal, the second terminal presenting guidance information of the target path based on the path information.

2. The method according to claim 1, wherein before the obtaining path information, the method further comprises:
performing position marking on the first virtual object to obtain first marking information, the first marking information comprising position information of the initial position in response to that the first terminal enters the path recording mode; and
the obtaining path information in response to that the first terminal is in the path recording mode and receives at least one marking operation comprises:
performing position marking on the first virtual object to obtain second marking information, the second marking information comprising position information of the marked position in response to that the first terminal is in the path recording mode and receives the marking operation; and
obtaining the path information in response to receiving a path information generation operation, the path information being configured for indicating the first marking information and one or more pieces of second marking information.

3. The method according to claim 2, wherein the performing position marking on the first virtual object to obtain second marking information in response to that the first terminal is in the path recording mode and receives the marking operation, comprises:
displaying a marking control in response to that the first terminal is in the path recording mode; and
performing position marking on the first virtual object to obtain one piece of second marking information in response to receiving a trigger operation on the marking control.

4. The method according to claim 3, wherein the displaying a marking control in response to that the first terminal is in the path recording mode comprises:
displaying an object marking control in response to that the first terminal is in the path recording mode and an interactive object exists in a specified range around the first virtual object, the interactive object being a virtual object having a function of interacting with the first virtual object.

5. The method according to claim 4, wherein the performing position marking on the first virtual object to obtain one piece of second marking information in response to receiving a trigger operation on the marking control, comprises:
performing position marking on the first virtual object to obtain second marking information corresponding to a target interactive object in response to receiving a trigger operation on the object marking control, the target interactive object being in the specified range around the first virtual object.

6. The method according to claim 5, wherein the performing position marking on the first virtual object to obtain second marking information corresponding to a target interactive object in response to receiving a trigger operation on the object marking control comprises:
performing position marking on the first virtual object to obtain the second marking information corresponding to the target interactive object in response to receiving the trigger operation on the object marking control after receiving a selection operation on the target interactive object; or
setting the interactive object in the specified range around the first virtual object to a to-be-selected state in response to receiving the trigger operation on the object marking control;
and performing position marking on the first virtual object to obtain the second marking information corresponding to the target interactive object in response to receiving the selection operation on the target interactive object.

7. The method according to claim 5, wherein the displaying an object marking control in response to that the first terminal is in the path recording mode and an interactive object exists in a specified range around the first virtual object comprises:
respectively displaying an object marking control corresponding to each interactive object in response to that the first terminal is in the path recording mode and the interactive object exists in the specified range around the first virtual object; and
the performing position marking on the first virtual object to obtain second marking information corresponding to a target interactive object in response to receiving a trigger operation on the object marking control, comprises:
performing position marking on the first virtual object to obtain the second marking information corresponding to the target interactive object in response to receiving a trigger operation on an object marking control corresponding to the target interactive object.

8. The method according to claim 5, wherein the second marking information corresponding to the target interactive object further comprises object information of the target interactive object.

9. The method according to claim 5, wherein the method further comprises:
adding a marking element to the target interactive object.

10. The method according to claim 5, wherein the method further comprises:
switching the object marking control to a first canceling marking control for display in response to receiving the trigger operation on the object marking control; and
canceling the second marking information corresponding to the target interactive object in response to receiving a trigger operation on the canceling marking control.

11. The method according to claim 5, wherein the method further comprises:
obtaining remark information corresponding to the remark operation in response to receiving a remark operation on the second marking information; and
adding the remark information to the second marking information.

12. The method according to claim 3, wherein the method further comprises:
canceling the second marking information in response to receiving a cancellation operation on the second marking information.

13. The method according to claim 1, wherein the transmitting the path information to a second terminal comprises:
displaying a copy control of the path information;
copying and pasting the path information into a chat input box in response to receiving a copy operation on the copy control and a paste operation on the chat input box with the second terminal; and
transmitting the path information to the second terminal in response to receiving a transmit operation on information in the chat input box.

14. The method according to claim 2, wherein the method comprises:
displaying an end recording control in response to that the first terminal is in the path recording mode; and
the obtaining the path information in response to receiving a path information generation operation comprises:
controlling the first terminal to exit the path recording mode in response to receiving a trigger operation on the end recording control, and obtaining the path information.

15. A path processing method in a virtual scene, the method being performed by a second terminal and comprising:
receiving path information transmitted by a first terminal, the path information being obtained by the first terminal when the first terminal is in a path recording mode and receives at least one marking operation, the path information being configured for indicating a target path, and the target path being a path formed by sequentially connecting an initial position to at least one marked position; the initial position being a position of a first virtual object when the first terminal enters the path recording mode, the marked position being a position of the first virtual object when the first terminal receives the marking operation; and the first virtual object being a virtual object controlled by the first terminal;
presenting guidance information of the target path based on the path information; and
controlling a second virtual object to sequentially move between the initial position and one or more marked positions in response to receiving a trigger operation on the guidance information.

16. A computer device, comprising a processor and a memory, the memory having at least one program stored therein, the processor being configured to execute the at least one program in the memory, to implement the foregoing path processing method in a virtual scene comprising:
displaying the virtual scene and a start recording control;
controlling the first terminal to enter a path recording mode in response to receiving a trigger operation on the start recording control;
obtaining path information in response to that the first terminal is in the path recording mode and receives at least one marking operation, and the target path being a path formed by sequentially connecting an initial position to at least one marked position, the path information being configured for indicating a target path, the initial position being a position of a first virtual object when the first terminal enters the path recording mode, the marked position being a position of the first virtual object when the first terminal receives the marking operation, and the first virtual object being controlled by the first terminal; and
transmitting the path information to a second terminal, the second terminal presenting guidance information of the target path based on the path information.

17. The computer device according to claim 16, wherein before the obtaining path information, the method further comprises:
performing position marking on the first virtual object to obtain first marking information, the first marking information comprising position information of the initial position in response to that the first terminal enters the path recording mode; and
the obtaining path information in response to that the first terminal is in the path recording mode and receives at least one marking operation comprises:
performing position marking on the first virtual object to obtain second marking information, the second marking information comprising position information of the marked position in response to that the first terminal is in the path recording mode and receives the marking operation; and
obtaining the path information in response to receiving a path information generation operation, the path information being configured for indicating the first marking information and one or more pieces of second marking information.

18. The computer device according to claim 17, wherein the performing position marking on the first virtual object to obtain second marking information in response to that the first terminal is in the path recording mode and receives the marking operation, comprises:
displaying a marking control in response to that the first terminal is in the path recording mode; and
performing position marking on the first virtual object to obtain one piece of second marking information in response to receiving a trigger operation on the marking control.

19. The computer device according to claim 18, wherein the displaying a marking control in response to that the first terminal is in the path recording mode comprises:
displaying an object marking control in response to that the first terminal is in the path recording mode and an interactive object exists in a specified range around the first virtual object, the interactive object being a virtual object having a function of interacting with the first virtual object.

20. The computer device according to claim 19, wherein the performing position marking on the first virtual object to obtain one piece of second marking information in response to receiving a trigger operation on the marking control, comprises:
performing position marking on the first virtual object to obtain second marking information corresponding to a target interactive object in response to receiving a trigger operation on the object marking control, the target interactive object being in the specified range around the first virtual object.
